(19) United States
(12) Patent Application Publication
(10) Pub. No.: US 2025/0030195 A1
(43) Pub. Date: Jan. 23, 2025

(54) SYSTEM COMPRISING A POWER TOOL AND AN ENERGY SUPPLY DEVICE

(71) Applicant: Hilti Aktiengesellschaft, Schaan (LI)

(72) Inventors: Markus HARTMANN, Mauerstetten (DE); Ralf MEIXNER, Germaringen (DE); Robert STANGER, Kaufbeuren (DE); Markus HOLUBARSCH, Landsberg am Lech (DE)

(21) Appl. No.: 18/714,660

(22) PCT Filed: Nov. 15, 2022
(86) PCT No.: PCT/EP2022/081928

§ 371 Date: May 30, 2024

(30) Foreign Application Priority Data
Dec. 1, 2021 (EP) 21211570.3

(51) Int. Cl. H01R 13/631; H01M 50/213; H01M 50/247

(52) U.S. Cl. CPC H01R 13/6315; H01M 50/213; H01M 50/247; H01M 2220/30

(57) ABSTRACT

A system including a machine tool and a power supply device, the power supply device being provided for supplying the machine tool with electrical power. The power supply device can be detachably connected to the machine tool by means of an interface, the interface coincluding at least one female contact partner and one male contact partner. The interface has at least one elastic means for reducing a relative movement between the male contact partner and the female contact partner, the at least one elastic device for reducing the relative movement between the contact partners being designed to engage with the at least one male contact partner and/or the at least one female contact partner. The power supply device includes at least one energy storage cell, the at least one energy storage cell having an internal resistance DCR_I of less than 10 milliohm. Methods for connecting a power supply device to a machine tool via an interface, and to an interface itself are also provided. A power supply device for use in the system.

The present invention relates to a system comprising a power tool and an energy supply device, wherein the energy supply device is provided for supplying the power tool with electrical energy. The energy supply device can be releasably connected to the power tool via an interface, wherein the interface comprises at least a female contact partner and a male contact partner. In a second aspect, the invention relates to an energy supply device for use in the system.

### BACKGROUND OF THE INVENTION

So-called cordless power tools, for example storage-battery-powered screwdrivers, drills, saws, grinders or the like, may be connected to an energy supply device in order to be supplied with energy. The energy supply device may for example be configured as or comprise a storage battery. Storage batteries usually have a multiplicity of energy storage cells, also known as storage battery cells, by means of which electrical energy can be received, stored and released again. If the storage battery is connected to a power tool, the electrical energy stored in the energy storage cells can be fed to the consumers (e.g. a brushless electric motor) of the power tool. For charging purposes, i.e. for loading the energy storage cells with electrical energy, the storage battery is connected to a charging device, such as a charger, such that electrical energy can enter the energy storage cells.

### SUMMARY OF THE INVENTION

When using or working with a battery-operated power tool, significant vibrations and shocks may occur in the power tool and in the energy supply device connected to the power tool. This is especially the case if the power tool is a demolition tool, e.g. a chipping or demolition hammer. The vibrations and shocks during the use of the power tool place a certain amount of strain on virtually all components and assemblies of the power tool and of the energy supply device. This strain may ultimately result in damage to the respective components or even to a total failure of the power tool as a whole.

In most cases the energy supply device and the power tool are connected to each other via a form-fitting connection, for example via a locking or a detent mechanism. Such form-fitting connections are generally afflicted by play, wherein the play allows undesirable relative movements between the energy supply device and the power tool. In particular if these relative movements are transferred to the contact partners of energy supply device and power tool which generate the form-fit and/or frictionally engaged connection, a greater level of wear may occur, which can significantly shorten the service life of the interface between energy supply device and power tool.

The interface between the power tool and the energy supply device constitutes a particular technical challenge. At the interface, the electrical contacts of the power tool and the electrical contacts of the energy supply device (“contact partners”) are connected to one another such that the electrical energy stored in the energy storage cells may be transferred from the storage battery to the power tool.

The vibrations and shocks in the power tool and in the energy supply device connected to the power tool may result in a relative movement and even in an actual break in the contact. The relative movement should be prevented since it may lead to wear or premature deterioration of the contacts. A break in the contact may result in undesired sparking or even an arc at the contacts. In addition, the temperature in the contact region between the electrical contacts or in the region of the interface may rise undesirably.

For example, EP 3 395 505 A1 discloses offset contacts on a storage battery that can supply electrical energy to a power tool. EP 3 392 974 A1 describes the spring mounting of a power contact of a storage battery. DE 10 2012 209 925 A1 discloses a hand-held power tool which can be supplied with electrical energy via a battery pack. The hand-held power tool has a contact holder for receiving electrical contacts.

It is an object of the present invention to overcome the deficiencies and disadvantages of the prior art described above and to provide an interface, a system consisting of a power tool and an energy supply device, and a method for connecting an energy supply device to a power tool, with which the power density of the interface can be improved and its service life can be extended. In particular, those skilled in the art would like to see the interface be capable of transmitting greater currents than before from the energy supply device to the power tool.

According to the invention, a system comprising a power tool and an energy supply device is provided, wherein the energy supply device is configured for supplying the power tool with electrical energy. The energy supply device can be releasably connected to the power tool via an interface, wherein the interface comprises at least a female contact partner and a male contact partner. The interface comprises at least one elastic means for reducing a relative movement between the male contact partner and the female contact partner, wherein the elastic means for reducing the relative movement between the contact partners is designed to act on the at least one male contact partner and/or on the at least one female contact partner. The energy supply device comprises at least one energy storage cell, wherein the at least one energy storage cell has an internal resistance DCR_I of less than 10 milliohms. The elastic means for reducing relative movement between the contact partners can engage one of the contact partners involved. In other words, the elastic means for reducing the relative movement between the contact partners can engage the at least one male contact partner or the at least one female contact partner, wherein the contact partners form a form-fit and/or frictionally engaged connection between the power tool and the energy supply device. In still other words, the elastic means can engage one of the contact partners, namely either the male contact partner or the female contact partner, to form a releasable connection between the power tool and the energy supply device. It is an essential advantage of the invention that particularly large electrical currents can be transmitted by means of the form-fit and/or interference-fit connection, and that surprisingly, the relative distances between the contact partners can be kept particularly short, if not quite reduced to a minimum. In this way, advantageously, the service life of the interface between the power tool and the energy supply device can be considerably extended. The female and male contact partners of the interface in the context of the invention may also preferably be described as “power contacts” of the interface.

By the provision of the at least one elastic means for reducing the relative movement, it is possible to easily compensate for vibrations and shocks acting on the contact partners, which may result in a relative movement and even an actual breaking of the contact connection between the storage battery and the power tool.

With the invention, in particular by the provision of the at least one elastic means for reducing a relative movement, a relative distance between the male and the female contact partner of the interface can be substantially reduced, so that mechanical friction losses and electrical current conduction losses between the contact partners can be reduced to a considerable extent. In particular, the invention can reduce a relative distance between the male and female contact partners of the interface to, for example, less than 0.3 mm, preferably less than 0.1 mm, and particularly preferably less than 0.05 mm.

The reduction of the relative movements or the shortening of the relative distances of the contact partners of the interface has several advantageous effects. A first effect relates to the relative movements or the relative distances between the contact partners that generate the form-fit and/or frictionally engaged connection between power tool and energy supply device. These relative movements or the relative distances can undesirably increase the contact resistance of the interface, wherein said increase is initially independent of the state of wear of the interface. In the context of the invention, this preferably means that the increased contact resistances may arise even in the new state of a system composed of power tool and energy supply device if, in the interface between the system components, undesired relative movements of the contact partners of the interface occur. Furthermore, the relative movements between the contact partners can lead to wear and ultimately oxidation, such that the contact resistance of the interface can disadvantageously increase further. In particular, wear of the noble layers of the contact partners can occur, which ultimately leads to atmospheric oxidation involving atmospheric oxygen and/or to fretting corrosion. By virtue of the fact that the invention considerably reduces the relative movements between the contact partners and thus the contact resistance, it contributes significantly to achieving that particularly high electrical currents can be transmitted from the energy supply device to the power tool by means of the interface. The invention furthermore reduces undesired wear of the contact partners, and thus likewise makes a valuable contribution to extending the service life of the interface.

It has been found that systems with energy supply devices with battery cells having an internal resistance of less than 10 milliohms can provide particularly high electrical currents for the power tool to be supplied. The provision of the spring-mounted contacts decisively contributes to the ability to transmit these currents for long periods under real usage conditions, such as for example on a construction site. Advantageously, with the energy supply device, particularly high-powered power tools can be operated as a battery-powered tool without a mains power connection. Such particularly high-powered power tools are for example chisel hammers or combination hammers, which often expose the user and the device components to severe vibrations. By providing the spring-mounted contacts in combination with the energy supply device, it may be ensured that even such particularly high-powered power tools can be operated as battery-powered tools with a secure and stable supply of electrical energy.

In addition, energy supply devices with battery cells having an internal resistance of less than 10 milliohms have a surprisingly long service life. This is attributable to a reduced heating of the energy supply device under comparable load. Because of the provision of the plurality of spring-mounted contacts, the relative movements between the female and male contact partners of the interface are reduced, so that the wear which usually occurs can be substantially reduced. Thus with the combination, according to the invention, of powerful batteries and spring-mounted contacts, a particularly durable and powerful system of power tool and energy supply device can be provided.

The longer service life of the powerful energy supply device provided according to the invention is also taken into account by the provision of a durable, robust interface. The invention provides a plug-in contact which can transmit high currents over a surprisingly long service life. The expression “long service life” in the context of the invention preferably means that the plug-in contacts are well suited for being connected to each other via multiple plugging cycles. The energy supply device and the power tool are separated and joined together again in such a way preferably whenever the energy supply device is “empty” and needs to be charged or replaced with a new energy supply device. Interfaces or contact partners thereof advantageously have low resistance values. This is supported by the reduced relative movements between the contact partners of the interface, which is advantageously made possible by the spring mounting of the contact partners. Tests have shown that spring forces which are adapted to the contact system can significantly reduce the wear or the abrasion at the contact partners of the interface.

The inventors have recognized that a battery system can sustain damage if a certain critical component temperature is exceeded at a point in the current path. In the context of the invention, the current path corresponds preferably to the electrical connection between the at least one battery cell and the motor of the power tool. In the context of the invention it is preferred that the current path leads via the spring-mounted contact system to the electronics of the power tool and on to the motor. In the short time, a high exceedance of a temperature may lead to immediate damage, but a low exceedance of a temperature may lead to time-dependent fatigue in the battery system of a power tool.

Elevated temperatures may arise, for example, as the result of high currents and/or resistances. They may occur both in the battery cell and in the conductor tracks or in the contact system, i.e., in the region of the interface between power tool and energy supply device.

Tests have shown that, by way of a very low internal resistance of battery cells, it is possible to provide high currents to the battery system and the power tool whilst at the same time increasing the service life of the battery cell. This is achieved in accordance with the invention in that the energy storage cells have an internal resistance DCR_I of less than 10 milliohms.

The contact resistance of a contact system, which is particularly critical, increases with increasing mechanical wear of the contact partners. This mechanical wear may be dependent, for example, on the collective tribological stresses, for example on a length of the relative distance and/or on the number of relative distances between the contact partners. The number of relative distances in the context of the invention preferably describes the sum of all relative distances during the service life of the energy supply device or the contact system. The number of relative distances means on the one hand the number of plugging and unplugging operations of the energy supply device, i.e., the number of plugging cycles, and on the other hand in particular the small, but very frequently occurring relative movement that occurs due to the dynamic loading of the contact system.

As already mentioned further above, above all the contact system, i.e., the interface between power supply device and power tool, is a key factor for whether or not thermal overload occurs. It is therefore preferred in the context of the invention that the contact resistance of the contact system increases minimally over the increased service life or particularly preferably remains substantially the same. It can thus be achieved advantageously that the energy supply device comprising battery cells that have a low internal resistance of less than 10 milliohms is designed to generate high currents over a long period of time without becoming overloaded.

The inventors have identified that of the factors influencing the thermal loading of the contact system, in particular the relative distance between the contact partners of the interface, i.e., between the female and male plug-in contacts of the energy supply device and the power tool, can be influenced, whilst other factors, such as the level of current to be transmitted or the service life of the contacts or the battery and thus the number of relative movements, can only be influenced to a lesser extent. It is therefore preferred in the context of the invention that the relative distance between the female and male contact partners is kept as short as possible. In other words, in the context of the invention the relative distance between plug-in contacts of the energy supply device and the power tool is reduced to a minimum. This is achieved in accordance with the invention in that the interface has at least one elastic means for reducing a relative movement between the contact partners, wherein the elastic means is designed to act on the at least one male contact partner and/or on the at least one female contact partner, and wherein the energy storage cells of the energy supply device have an internal resistance DCR_I of less than 10 milliohms.

Tests have shown that biased, movable contacts solve this problem particularly well, in particular at high currents and with long-lasting, high accelerations and high dust loading. These biased, movable contacts are referred to in the context of the invention preferably as “spring-mounted” female and male contact partners of the energy supply device and the power tool. The spring mounting is achieved in particular by the provision of elastic means. These elastic means are preferably designed to shorten the relative distances between the contact partners of the interface. This preferably means, in the context of the invention, that the female and male contact partners of the energy supply device and of the power tool have to cover only a shorter friction distance than in conventional contact systems, and therefore the mechanical wear at the contact partners can be significantly reduced. In the context of the invention, it is preferred that the spring mounting may be present in the region of the power tool and/or in the region of the energy supply device. Alternatively or additionally, the male and/or the female contact partners of the interface can be spring-mounted, i.e., can comprise elastic means for shortening the relative distances.

It has been found that, due to the combination of improved battery cells, which can provide high currents to the battery system and the power tool, and a low-wear contact system, which over a long service life ensures a constant contact resistance, it is possible to create a very powerful, durable and economical battery system for electric power tools. This is achieved in accordance with the invention in that the interface has at least one elastic means for reducing a relative movement between the contact partners, wherein the elastic means is designed to act on the at least one male contact partner and/or on the at least one female contact partner, wherein the energy storage cells of the energy supply device have an internal resistance DCR_I of less than 10 milliohms.

In the context of the invention, it is preferred that the elastic means for shortening the relative distances between the power contacts of the interface lead to a mechanical decoupling between energy supply device and unit composed of male and female contact partners. Alternatively, the elastic means may lead to mechanical decoupling between the power tool and the unit composed of male and female contact partners. Owing to the mechanical decoupling, any undesired relative movement between the contact partners is not transmitted, but is advantageously compensated by the elastic means.

Tests have shown that the invention can effectively prevent an undesirable increase in temperature in the contact region between the male contact partner and the female contact partner. For example, the temperature measured in the contact region between the contact partners can be reduced by up to 30 degrees because the grade and quality of the contact between the contact partners can be significantly improved with the invention, i.e., by providing the elastic means to reduce the relative movement. The improvement of the contact resistance advantageously leads to an increased current-carrying capacity of the interface, such that the invention allows operation of or electrical energy supply to power tools in higher power classes, i.e. particularly high-powered power tools. The reduction in power losses in the contact resistance may advantageously lead to a reduced thermal load on the surrounding components. In particular, components composed of thermoplastic material can thus be effectively protected from damage owing to excessive introduction of heat.

The temperature reduction leads advantageously to the fact that the service life of the components of the interface between the power tool and the energy supply device can be lengthened. The temperature reduction is brought about advantageously by the fact that the contact resistance between the power tool and the energy supply device can be significantly reduced by the more stable contact or the reduced relative path between the contact partners.

In the context of the invention, it is preferred that the contact partner on which the elastic means for reducing the relative movement acts is movably mounted. In other words, the contact partner with which the elastic means for reducing the relative movement is operatively connected, may be movably mounted. In the context of the invention, it is preferred that the movably mounted contact partner and/or the movably mounted receiving device is spring-mounted. If more than one contact partner is provided per connection partner of the interface, or if the power tool and/or the energy supply device have/has more than one receiving device, it may be preferred in the context of the invention that the movably mounted contact partners and/or the movably mounted receiving devices are spring-mounted. In this way, the relative movements between the contact partners, and the contact resistance, can be further considerably reduced, and the service life of the interface considerably extended. It may additionally be preferred that the elastic means for reducing the relative movement acts on a receiving device which will be described later. The receiving device may receive male and/or female power contacts, and may likewise be movably mounted. The receiving device is movably mounted in particular if it is operatively connected to the at least one elastic means for reducing the relative movement between the power contacts, or if said elastic means act on the receiving device. The statement that the at least one elastic means for reducing the relative movement between the contact partners is configured to act on the at least one male contact partner or on the at least one female contact partner preferably means, in the exemplary embodiment of the invention in which individual contact partners are arranged in a receiving device, means that the at least one elastic means for reducing the relative movement between the contact partners is configured to act on the receiving device in which individual contact partners are contained. The receiving device may form a contact block or contact means block which can be movably mounted or spring-mounted by the elastic means. In the context of the invention, it is preferred that the receiving device comprises the contact partners of a connection partner of the interface, i.e. power tool or energy supply device. However, in the context of the invention, it may also be preferred that several receiving devices are provided, which may each receive a sub-quantity of the contact partners of a connection partner. These several receiving devices may preferably also be spring-mounted by virtue of the elastic means for reducing the relative movement acting on these several receiving devices. Thus the receiving devices may comprise the power contacts, i.e. the female and male contact partners, and/or the communication elements. In the context of the invention, it is preferred that elastic means for reducing the relative movement are also described as “elastic spring-mounting means”.

Preferably, the contact partner, on which the elastic means for reducing relative movement acts, is mounted so as to be movable relative to the power tool or relative to the energy supply device in the connected state. If the spring mounting is provided on the power tool side, i.e. the at least one elastic means acts on the contact partner or the receiving device of the power tool, the resulting spring mounting in the region of the power tool preferably contributes to achieving that the corresponding contact partner, when in the connected state, is mounted so as to be movable relative to the power tool. If the spring mounting is provided on the energy supply device side, i.e. the at least one elastic means acts on the contact partner or the receiving device of the energy supply device, the resulting spring mounting in the region of the energy supply device preferably contributes to achieving that the corresponding contact partner, when in the connected state, is mounted so as to be movable relative to the energy supply device.

The statement that the elastic means for reducing the relative movement between the contact partners is configured to act on the at least one male contact partner and/or on the at least one female contact partner firstly includes the possibility that the elastic means acts on one of the groups of contact partners, for example on all contact partners, which are arranged on the energy supply device, or on all contact partners which are arranged on the power tool. In the context of the invention, it may however also be preferred that both the power tool and the energy supply device comprise elastic spring-mounting means for the contact partners thereof. In this embodiment of the invention, the elastic means acts on the at least one male contact partner and on the at least one female contact partner. If one or both groups of contact partners is arranged in a receiving device, the elastic means may act on one of the receiving devices. If the contact partners both of the energy supply device and of the power tool have a receiving device, the elastic means may also act on both receiving devices. Action both on the contact partners of the power tool and on the contact partners of the energy supply device may be implemented for example by virtue of a hard spring being used in the case of one of the connection partners—energy supply device or power tool—and a soft(er) spring being used in the case of the other connection partner—power tool or energy supply device. The term “hard spring” is to be understood in the context of the invention as a spring with a high spring stiffness, while the term “soft spring” is to be understood in the context of the invention as a spring with a lower spring stiffness.

In the context of the invention, it is preferred that the at least one male contact partner is arranged on the power tool. The male contact partners may comprise blades which may be inserted in a female contact partner of the interface or other system component. According to an advantageous embodiment of the present invention, provision may be made for the male contact partners to be designed as pin-like plug connectors or blades, and the female contact partners of the interface as terminals with elastically deformable legs for receiving the pin-like plug connectors or blades. The male contact partner may be formed by a protruding region and a stop, wherein the protruding region, in a plugged state of the interface in which the energy supply device is connected to the power tool (therefore also: “in the connected state”), is introduced into one of the female contact partners. In an unconnected state, the power tool and the energy supply device may be independent and separate from one another. This may be the case for example when the energy supply device is being charged and is arranged in a charger in order to be charged. In the context of the invention, it may also be preferred that the at least one male contact partner is arranged on the energy supply device.

The energy supply device may preferably comprise at least one storage battery (accumulator), wherein the energy supply device is designed to supply the power tool with electrical energy. Electrical energy is output from the energy supply device to the power tool in particular in the connected state in which the power tool has been connected to the energy supply device via the interface. The female and male contact partners engage with one another when in the connected state, such that electrical current or electrical energy can flow between the contact partners via a contact region. Tests have shown that, by using the at least one elastic means for reducing a relative movement between the contact partners, said elastic means engaging at least one of the contact partners, significantly higher currents can be transmitted than with conventional contact systems as is the case from the prior art. For example, the invention allows the transmission of constant currents in a range in excess of 50 amperes, preferably in excess of 70 amperes, or particularly preferably in excess of 100 amperes.

The reason that higher electrical currents can flow from the energy supply device toward the power tool with the interface, which has at least one elastic means, is because the energy supply device is decoupled from the at least one contact pair of female and male contact partner. This decoupling will be described in greater detail below.

The at least one elastic means for reducing the relative movement can preferably comprise at least one elastic element, such as a spring. Here, the elastic element may be configured in the form of a spring, and in particular as a spiral, bending or coil spring. Alternatively, the elastic element may be configured as a component composed of an elastically deformable material. An elastomer is also a possible material in this case. It is thus possible to easily counteract a vibration-related movement of the connection element in multiple directions, i.e. not only in the direction toward or away from the connection element. In addition, the undesired relative movements between the contact partners of the interface can be effectively shortened through the use of an elastic element.

In the context of the invention, it is preferred that, on insertion into the female contact partner, the male contact partner compresses the least one elastic means such that the elastic means is brought into a stressed state. This compressing may preferably constitute an elastic deformation or a compression. Preferably, the terms “compressing”, “compression” and “elastic deformation”, and the corresponding verbs, are used synonymously in the context of the present invention. The compressing of the elastic means advantageously leads to the stressed state. Alternatively or additionally, the at least one male contact partner may also be spring-mounted. In the context of the invention, the term “spring mounting” is to be understood to mean that the spring-mounted contact partner is operatively connected to the elastic means for reducing relative movements between the contact partners. In other words, the elastic means for reducing the relative movements between the contact partners can act on one of the contact partners, whereby advantageously a spring mounting of the corresponding contact partner is achieved. In the context of the invention, it is preferred that, when in the inserted, connected or locked state, in which the energy supply device and the power tool have been connected together, the at least one elastic means is in a stressed or tensioned state. In the context of the invention, it is preferred that the elastic means are biased even when in the uninstalled state, wherein a force flow within the energy supply device is closed by said elastic means. The at least one female contact partner may thereby be supported on the energy supply device. The stress of the at least one elastic means for reducing relative movement between the contact partners, in particular when the contact system is in the connected state, causes the male and female contact partners to be pressed firmly against one another such that particularly good contact is formed between the contact partners. Owing to this “spring-mounted” contacting of the contact partners, or owing to the particularly close contact of the contact partners, the power density of the resulting contact can be considerably increased, such that it is made possible to transmit constant electrical currents in a range of more than 50 amperes, preferably more than 70 amperes, or particularly preferably more than 100 amperes. Also, the service life of the contact system can be substantially extended, such that the contact system is particularly suitable for energy supply devices with long service lives and/or high output currents, because the relatively high mechanical and/or electrical requirements on an interface can be optimally satisfied by means of the invention.

In the context of the invention, it is preferred that, as the energy supply device is connected to the power tool, the energy supply device is introduced for example into a cavity of the power tool. In order to establish the electrical connection between the connection partners of “energy supply device” and “power tool”, in a first step, the contact partners are brought into contact with one another. This preferably takes place by virtue of the blades of the male contact partners being introduced into the receiving terminals of the female contact partners. This process is preferably also referred to in the context of the invention as “bringing the contact partners together”. In particular, it is preferred in the context of the invention that the movably mounted contact partner(s) is/are pushed onto the stationary contact partner(s), wherein the play or freedom of movement is advantageously provided by the invention in the region of the movably mounted contact partner. Then, in a second step, the at least one elastic means is stressed, for example by virtue of the elastic element being compressed or elastically deformed. Then additional mechanical fixing or locking mechanisms may engage, for example the locking elements may engage or come to rest in recesses, depressions or undercuts provided for this purpose. In the context of the invention, it is particularly preferred that the stress of the elastic element is present in the locked state. In other words, the elastic element may be in a compressed state in particular when the energy supply device has been connected to the power tool. The advantageous play and the freedom of movement of the spring-mounted contact partners or of the spring-mounted receiving device(s) are preferably also present in the connected state. In the context of the invention, it is preferred that the locking of the energy supply device in the power tool takes place in a force flow of the interface.

Thus, in the context of the present invention, a method is disclosed for connecting an energy supply device to a power tool, wherein the method is characterized by the following method step:
a) bringing together the contact partners of the energy supply device and of the power tool,
b) stressing the at least one elastic spring-mounting means,
c) engaging any locking elements with detent action in order to stably fix the energy supply device in the power tool.

In the context of the invention, it is preferred that the at least one female contact partner is arranged on the energy supply device. The at least one female contact partner may preferably be formed by a receiving terminal which is designed to receive the blade of the male contact partner. For this, the female contact partner may have two legs composed of an elastic material, wherein the legs are pushed apart on insertion of the male contact partner such that the male contact partner comes to lie in an interior of the female contact partner or of the receiving terminal. In the context of the invention, this situation is referred to as the connected or plugged-together state of the interface. Owing to the elasticity of the material from which the legs of the female contact partner are formed, the legs of the receiving terminal of the female contact partner in this connected state press on the blade or the protruding region of the male contact partner, such that a contact region is created between the contact partners. Preferably, electrical current or electrical energy is exchanged between the contact partners via this contact region, such that current or electrical energy can flow from the energy supply device toward the power tool. In the context of the invention, it may also be preferred that the at least one female contact partner is arranged on the power tool. It can also be preferred in the context of the invention for preferably electrical control signals to be exchanged between the power tool and the energy supply device via the power contacts. These preferably electrical control signals are preferably to be distinguished from the preferably digital control signals and data that can be exchanged via the communication elements and/or via the communication link between the “energy supply device” and “power tool” connection partners. The preferably electrical control signals which can be exchanged with the aid of the power contacts, i.e., the female and the male contact partners, preferably have a current strength of less than 1 ampere, whereas the electrical currents which can flow from the energy supply device toward the power tool can be much greater than 1 ampere.

The legs of the female contact partner may preferably be formed from a good conductor, such as copper, in the contact regions to the male contact partner. The female contact partners may in addition comprise over-springs of spring steel, wherein the over-springs are preferably configured to press the legs of the female contact partners together so that when connected, a stable contact exists between the female and male contact partners. As well as spring steel, other metals or metal alloys with elastic properties may be used to produce the female contact partners. For the contact regions used to transmit electrical energy, materials with good conductivity, a high yield strength and/or high relaxation strength are very particularly preferred, such as for example CuFe2P or CuCrSiTi. The contact regions may preferably be situated on the insides of the legs of the female contact partners, where they come into contact with the blades of the male contact partners when connected.

In the context of the invention, it is preferred that the legs of the female contact partner or of the receiving terminal have a minimal spacing in the contact region so as to allow particularly good contact with the male contact partner. In the contact region with respect to the male contact partner, the female contact partner preferably has a taper that is defined by the minimal spacing between the legs of the female contact partner. In the context of the invention, it is preferred that the legs of the female contact partner comprise copper or are coated with a copper layer in the contact region or in the region of the taper or in the region of the minimal leg spacing. In addition, coatings comprising nickel and/or silver may be used without being limited thereto. By means of the coating material, which is preferably present in the contact region between male and female contact partners of the interface, the current flow or the flow of electrical energy from the energy supply device to the power tool can be further optimized, such that it is in particular also possible for high currents, for example 50 amperes, 70 amperes or 100 or more amperes, to flow through the interface. In the context of the present invention, the currents can be in particular contact currents.

By virtue of the fact that the energy supply device is releasably connected to the power tool by means of the interface, the respective electrical contacts of the power tool and of the energy supply device preferably bear against one another in a frictionally engaged fashion. Here, the female contact partner may comprise a preferably resiliently mounted clamp or receiving terminal, whilst the male contact partner may have an insert element that can be inserted into the clamp or the receiving terminal.

It is preferred in the context of the invention that the at least one elastic means for reducing the relative movement comprises at least one elastic element. Preferably, the male contact partner and the female contact partner can form a unit in the connected state, which is produced by inserting the male contact partner into the female contact partner. It is preferred in this embodiment of the invention that the elastic means for reducing the relative movement between the contact partners is operatively connected to the unit of female contact partner and male contact partner, i.e., engages the unit or one of the contact partners of the interface. In the connected state, the unit of male and female contact partner can be pushed toward the power tool or toward the energy supply device such that the energy supply device can move independently of the unit of male and female contact partner. This causes the vibration-sensitive unit of male and female contact partner unit to be decoupled from the energy supply device, wherein the decoupling of the unit and the energy supply device significantly improves the load-bearing capacity of the interface, its service life, and its robustness with respect to undesirable heating. Surprisingly, by providing the at least one elastic means for reducing the relative movement, the unit of male and female contact partner can be provided with a movement space, referred to as “play” in the context of the invention. Within this movement space, the unit can move without impacting on the boundary walls of the movement space. If the unit of male and female contact partner is mounted in a stationary manner to the power tool or to the energy supply device, the energy supply device can move around the unit independently of the unit, so that the movement of the energy supply device is decoupled from the unit of male and female contact partners, which is sensitive to contact and vibration.

Tests have shown that by providing the elastic means for reducing the relative movement at the interface, fretting corrosion (fretting) between the contact partners of the interface can be substantially reduced. In this way for example, either lower quality, cheaper coatings of the contact partners may be used, or the use of the at least one elastic means for reducing the relative movement leads to a longer service life of the interface and a higher power density, wherein the higher power density in the context of the invention preferably means that higher electrical currents can be transmitted through the interface of male and female contact partners.

The invention cannot prevent an undesired movement or oscillation of the energy supply device, but the at least one elastic means for reducing the relative movement advantageously ensures that the pairs of male and female contact partners of the energy supply device and/or power tool, which are susceptible to contact and vibration, are decoupled and thus protected from their movements and vibrations.

In the context of the invention, it is preferred that at least one male and one female contact partner in each case form a unit, wherein in a connected state, this unit is decoupled from a movement of the energy supply device and/or power tool. Advantageously, this decoupling of the unit of male and female contact partners and the energy supply device is in particular achieved by the at least one elastic means for reducing the relative movement which acts on one of the contact partners or on the unit of at least one male and female contact partner. In other words, in the context of the invention, it is preferred that the elastic means are configured to reduce the relative movement between the contact partners and to act on one of the contact partners or on the unit of a male and a female contact partner. The decoupling of the unit from the energy supply device arises in particular if the at least one elastic means for reducing the relative distances between the contact partners is present on the energy supply device. In the context of the invention, however, it may also be preferred that the at least one elastic means for reducing the relative distances between the contact partners is present on the power tool. In this case, the unit of male and female contact partners may preferably be decoupled from the power tool.

It is preferred in the context of the invention that the interface comprises one to eight, preferably two to six, and most preferably four, female contact partners. Preferably, the interface has a corresponding number of male contact partners, so that in each case one male contact partner and one female contact partner can form a contact pair. In the context of the invention it can also be preferred, however, that a connection partner of the interface—power tool or energy supply device—comprises two male contact partners, whereas the other connection partner of the interface—energy supply device or power tool—comprises four female contact partners. In this exemplary embodiment, two current transmission pairs formed in each case of a male and a female contact partner would be formed, whereas two female contact partners would remain unused and “empty”. In the context of the invention it is preferred that the male contact partners are arranged on the power tool, whereas the female contact partners are arranged on the energy supply device. Of course, it may also be preferred in the context of the invention that the male contact partners are arranged on the energy supply device, while the female contact partners are arranged on the power tool.

It is also preferred in the context of the invention if the interface comprises a receiving device for receiving at least one female contact partner and/or at least one male contact partner. In other words, the receiving device may be configured to receive at least one female contact partner or at least one male contact partner, or at least one female and at least one male contact partner. In a preferred exemplary embodiment of the invention, the receiving device may receive at least one female contact partner. In the context of the invention, it may be preferred that the female contact partners are arranged individually on the interface, or that they are part of a receiving device, wherein the individual female contact partners or the receiving device may be components of either the power tool or the energy supply device. In the context of the invention, it is most preferred that the individual female contact partners or the receiving device are/is part of the energy supply device.

If the power tool and/or the power supply device has/have a receiving device for receiving the relevant contact partners, i.e., the power contacts, this receiving device can also be designed to receive the communication contacts. In other words, the receiving device can comprise, besides the power contacts, also communication elements. In the context of the present invention it can also be preferred that the receiving device comprises “only” power contacts, whereas the interface between power tool and energy supply device comprises a further receiving device for solely receiving the communication elements. Preferably, this “communication receiving device” can also be spring mounted by comprising an elastic means or by an elastic means acting on the “communication receiving device”. The “communication receiving device” in the context of the invention can preferably also be referred to as a “communication block”, wherein this “communication block” in a very particularly preferred embodiment of the invention can be spring mounted in their own right, i.e., independently of the power contacts and their receiving devices. In the context of the invention it is preferred that the communication elements are arranged in a communication receiving device, wherein the communication elements can individually have elastic means in their own right for spring mounting. In other words, the communication elements can be spring mounted individually by each having an elastic means for spring mounting. If the communication elements are present arranged in a communication receiving device, the communication receiving device can have its own elastic means for spring mounting.

In the context of the invention, it is preferred that the energy supply device has an even number of contact partners, wherein the contact partners may be female and/or male contact partners. The energy supply device preferably has a positive pole and a negative pole, wherein each of the two poles is connected to a contact partner, i.e. has a contact partner. For example, the energy supply device may have two, four, six, eight or more contact partners which may be spring-mounted individually or in a contact block. Preferably, half of the contact partners may be assigned to the negative pole of the energy supply device, while the other half of the contact partners may be assigned to the positive pole of the energy supply device.

The receiving device may form a compartment or a cassette in which female contact partners and/or male contact partners can be received. A contact block can advantageously be provided in this way, such that the female contact partners can move conjointly or be moved conjointly. The receiving device can preferably receive one to eight, preferably two to six, and most preferably four, female contact partners. If the receiving device also comprises communication elements, the receiving device can comprise, for example, four power contacts and two communication elements.

In the context of the invention, it is preferred that the contact partners of the interface are individually spring-mounted, or that a contact block formed by the contact partners is spring-mounted as a whole. If the contact partners are individually spring mounted, the contact partners may be individually operatively connected to the elastic means for reducing the relative path. If the interface comprises for example four contact partners at one of the system elements, i.e. power tool or energy supply device, an elastic means or elastic element may be assigned to each of these four contact partners. Preferably, in this embodiment of the invention, this is referred to as “individual spring mounting of the power contacts of the interface”. Alternatively, in the context of the invention, it may be preferred that an entire contact block, which preferably comprises several contact partners—female and/or male—is spring-mounted as a whole. Such a contact block in the context of the invention is also preferably described as a contact means block, wherein the contact means block may be formed by a receiving device with power contacts. It is preferred in the context of the invention that the contact block or the receiving device is operatively connected to an elastic means or an elastic element. This means preferably, in the context of the invention, that an elastic means or elastic element is assigned to the contact block or receiving device. Preferably, in this embodiment of the invention, this is referred to as a “spring-mounted receiving device” or a “spring-mounted contact means block”. It is preferred in the context of the invention that the interface comprises communication elements for exchanging data between the power tool and the energy supply device. For example, the interface may comprise at least two communication elements, wherein a first communication element is arranged on the power tool and a second communication element is arranged on the energy supply device. The communication elements may be configured to establish a communication link between the power tool and the energy supply device, wherein the communication link may be wire-based or without wires. In other words, the communication link between the power tool and the energy supply device may be of wired or “wireless” design. For example, wireless communication between the power tool and the energy supply device may be based on Bluetooth, WLAN, Zigbee, radio, near-field communication, or the like. For example, transmitters and receivers can be provided as communication elements.

In a preferred exemplary embodiment of the invention, the interface comprises four power contacts and two communication elements. The power contacts and the communication elements may be arranged together in a receiving device, wherein an elastic spring-mounting means is associated with the common receiving device. However, it may also be preferred in the context of the invention that the power contacts are individually spring mounted and the communication elements have their own communication receiving device. Individual spring mounting of the power contacts of the interface can be provided by the fact that elastic means are assigned to the movably mounted power contacts of the interface.

It may be preferred in the context of the invention for the communication elements to be integrated in the receiving device. In other words, the receiving device may comprise at least one communication element for transmitting data between the power tool and the energy supply device. In the context of the invention, the communication elements may preferably also be referred to as “communication plugs”, in particular if the communication link is of the wired type. In the context of the invention, it is very particularly preferred that the receiving device has two communication elements, wherein the communication elements can preferably be arranged centrally within the receiving device.

In a preferred embodiment of the invention, the power contacts of the interface, i.e., the female and the male contact partners of the interface, can be individually spring-mounted, while a separate small receiving device is provided for the communication elements of the interface, thus forming a separate compartment or cassette for the communication elements. The receiving device for the communication elements can also be part of the interface between the power tool and the energy supply device.

It is preferred in the context of the invention that the at least one elastic means for reducing the relative movement is assigned to the receiving device, preferably as a whole. In this case, it is for example possible for a receiving device, which can receive four female contact partners, for example, to be connected by means of an elastic element to the corresponding system component—power tool or energy supply device. The decoupling then takes place for example between the energy supply device and the receiving device, such that the female contact partners in the receiving device are decoupled or protected from movements and/or vibrations of the energy supply device and/or of the power tool. Tests have shown that the use of a receiving device offers particularly good protection against tilt movements, and the friction moment between the contacts is considerably increased. The receiving device with the power contacts may preferably form a contact block, wherein, by means of the invention, this preferably movably mounted or spring-mounted contact block is particularly well protected against tilting movements or the like. This advantage of the invention may be achieved by virtue of support surfaces and the friction forces of the individual terminal contacts of the female contact partners being spaced far apart from one another laterally or substantially perpendicularly with respect to the insertion direction, and dynamic tilting moments thus being able to be particularly well absorbed owing to the large lever arm of the mounting. The same applies to the support surfaces of a contact block if the female contact partners are received by a receiving device. The statements above also apply analogously to male contact partners, in particular if they are received by a receiving device and form a contact block.

Alternatively, it may be preferred that the at least one elastic means for reducing the relative movement is assigned to a respective contact pair of female and male contact partners. In this case for example, each contact pair of female and male contact partners may have its own elastic means for reducing the relative movement, such as an elastic element, and be decoupled or protected from the movements and/or vibrations of the energy supply device and/or power tool by means of the elastic means.

According to one exemplary embodiment of the invention, elastic means are disclosed which can counteract a relative movement between the energy supply device and the power tool. In this case, the energy supply device and power tool are releasably connected to each other via an interface, wherein the interface comprises male and female contact partners. In particular, the female contact partners may be in the form of individual contacts, wherein each female contact partner is configured to receive a male contact partner or blade thereof. Alternatively, the female contact partners can form a contact block or can be present in a receiving device, wherein the contact block or the receiving device can preferably be part of the energy supply device or the power tool. In the context of the invention, it is particularly preferred that the female contact partners are arranged on the energy supply device. It may however also be preferred that the female contact partners are arranged on the power tool. Similarly, the male contact partners may be provided in the form of individual contacts, wherein in each case a male contact partner is configured to form a contact pair with a female contact partner having a contact region for the transmission of electrical energy. Alternatively, the male contact partners may form a contact block which may be part of the energy supply device or the power tool. In the context of the invention, it is particularly preferred that the male contact partners are arranged on the power tool. In the context of the invention, it may also be preferred that the male contact partners are arranged on the energy supply device. The at least one elastic means for reducing the relative movement between the contact partners is preferably designed to prevent or reduce a relative movement between the contact partners of the interface or the power tool and the energy supply device. The at least one elastic means for reducing the relative movement can act here individually on the male and/or on the female contact partners of the interface. However, it may just as well be preferred in the context of the invention that the at least one elastic means for reducing the relative movement acts on the contact blocks or the receiving device for the female contact partners, which are formed by mostly two to eight contact partners. The individual female and/or male single contacts or the contact blocks formed from them can be arranged both on the power tool and on the energy supply device, wherein an arrangement of the female contact partners in the region of the energy supply device and an arrangement of the male contact partners in the region of the power tool is particularly preferred.

The invention also relates to an interface for transmission of electrical energy between a power tool and an energy supply device. The terms, definitions and technical advantages presented for the system of power tool and energy supply device preferably apply accordingly to the interface, the energy supply device described further below, and the method for connecting an energy supply device to a power tool by means of an interface. The interface is characterized in that the interface has at least one male contact partner and at least one female contact partner, as well as at least one elastic means for reducing a relative movement between the male contact partner and the female contact partner.

In addition, the invention relates to a method for connecting an energy supply device to a power tool by means of an interface, which is characterized in that the interface has at least one male contact partner and at least one female contact partner, wherein the male contact partners and the female contact partners, during creation of a contact for the purpose of transmission of electrical energy from the energy supply device to the power tool, are supported by at least one elastic means for reducing a relative movement. In the context of the invention, it is preferred that a male and a female contact partner in each case form a unit, wherein the unit, in a connected state, is decoupled from a movement of the energy supply device.

In a second aspect, the invention relates to an energy supply device for use in the system. The energy supply device is preferably an energy supply device with a particularly long service life, and/or an energy supply device which is configured to output particularly high currents, in particular constant currents of more than 50 amperes, preferably more than 70 amperes, and most preferably more than 100 amperes.

The energy supply device may preferably be a storage battery or a preferably rechargeable battery. In the context of the invention, it is self-evidently also possible that the energy supply device has two or more storage batteries and/or batteries. The storage batteries and/or batteries may have so-called battery packs which, for example, comprise cylindrical cells. These cylindrical cells may for example contain a chemical substance comprising lithium ions, magnesium ions and/or sodium ions, without being restricted thereto. However, other cell types, for example with cuboid or cubic cells, may also be used in the context of the present invention.

The energy supply device is preferably an energy supply device with a particularly long service life, and/or an energy supply device which is configured to output particularly high currents, in particular constant currents of more than 50 amperes, preferably more than 70 amperes, and most preferably more than 100 amperes. The particularly long service life can preferably result in the energy supply device surviving a particularly large number of insertion processes or insertion cycles without wearing out. In addition, the particularly long service life can mean that the chemical components of the energy supply device are designed to be able to be charged more frequently than previous energy supply devices without significantly aging. A major advantage of the contact system consists in that such high-powered energy supply devices can be reliably and easily connected thereto. In particular, owing to the spring mounting by the elastic means, the contact system is capable of transmitting high currents and, at the same time, of being used throughout the entire service life of the energy supply devices without sustaining wear. In this way, the advantages of new cell and battery technologies can be optimally utilized by means of the invention. With the invention, it is consequently possible to provide a system composed of power tool and energy supply device, which system allows efficient use of energy supply devices in battery-operated power tools, in particular also for applications and uses which impose very stringent electrical power requirements and/or very stringent service life requirements on the system or its interface.

In the context of the invention, it is preferred that the energy supply device comprises at least one cell, wherein the at least one cell has an internal resistance DCR_I of less than 10 milliohms (mohm). In preferred embodiments of the invention, the internal resistance DCR_I of the at least one cell may be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein any components or accessories of the cell do not make any contribution to the internal resistance DCR_I. A low internal resistance DCR_I is advantageous, as this means that unwanted heat that needs to be dissipated does not arise at all. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the cooling expenditure can be kept surprisingly low. In particular, an energy storage device with a cell internal resistance DCR_I of less than 10 milliohms is particularly well suited to supplying electrical energy to particularly powerful power tools. Such energy supply devices can therefore make a valuable contribution to allowing storage-battery-operated power tools to be used even in areas of application that those skilled in the art previously assumed were not open to storage-battery-operated power tools.

Advantageously, such an energy supply device can be used to allow a battery-operated or storage-battery-operated power tool having an energy supply device according to the invention to be supplied with a high level of output power over a long period of time without damaging the surrounding plastics components or the cell chemistry within the cells of the energy supply device.

It is preferred in the context of the invention that a ratio of a resistance of the at least one cell to a surface area A of the at least one cell is less than 0.2 millionm/cm², preferably less than 0.1 milliohm/cm² and most preferably less than 0.05 milliohm/cm². In the case of a cylindrical cell, the surface area of the cell can be formed, for example, by the outer surface of the cylinder as well as the top side and the bottom side of the cell. Furthermore, it can be preferred in the context of the invention for a ratio of a resistance of the at least one cell to a volume V of the at least one cell to be less than 0.4 milliohm/cm³, preferably less than 0.3 millionm/cm³ and most preferably less than 0.2 milliohm/cm³. For conventional geometric shapes, such as cuboids, cubes, spheres or the like, a person skilled in the art knows the formulae for calculating the surface area or the volume of such a geometric body. In the context of the invention, the term “resistance” preferably denotes the internal resistance DCR_I which can preferably be measured in accordance with standard IEC61960. This is preferably a DC resistance.

It is preferred in the context of the invention for the at least one cell to have a heating coefficient of less than 1.0 W/(Ah·A), preferably less than 0.75 W/(Ah·A) and particularly preferably less than 0.5 W/(Ah·A). Furthermore, the at least one cell can be designed to output a current of greater than 1000 amperes/liter substantially constantly. The discharge current is indicated in relation to the volume of the at least one cell, wherein the volumetric measurement unit “liter” (I) is used as the unit for the volume. The cells according to the invention are therefore able to output a discharge current of substantially constantly greater than 1000 A per litre of cell volume. In other words, a cell with a volume of 1 liter is able to output a substantially constant discharge current of greater than 1000 A, wherein the at least one cell furthermore has a heating coefficient of less than 1.0 W/(Ah·A). In preferred configurations of the invention, the at least one cell of the energy supply device may have a heating coefficient of less than 0.75 W/(Ah·A), preferably less than 0.5 W/(Ah·A). The unit for the heating coefficient is watts/(ampere hours·amperes). The heating coefficient can of course also have intermediate values, such as 0.56 W/(Ah·A); 0.723 W/(Ah·A) or 0.925 W/(Ah·A).

The invention advantageously allows the provision of an energy supply device having at least one cell which has reduced heating and therefore is particularly well suited for supplying power tools in which high power outputs and high currents, preferably constant currents, are desired for operation. In particular, the invention can be used to provide an energy supply device for a power tool in which the heat which is optionally created during operation of the power tool and when outputting electrical energy to the power tool can be dissipated in a particularly simple and uncomplicated manner. Tests have shown that the invention can not only be used to more effectively dissipate existing heat. Rather, the invention prevents heat being generated or the quantity of heat generated during operation of the power tool can be considerably reduced using the invention. The invention can advantageously be used to provide an energy supply device which can supply electrical energy in an optimum manner primarily also to power tools which have stringent requirements in respect of power and discharge current. In other words, the invention can provide an energy supply device for particularly powerful power tools with which heavy drilling or demolition work can be performed on construction sites for example.

In the context of the invention, the term “power tool” should be understood to mean a typical piece of equipment that can be used on a construction site, for example a building construction site and/or a civil engineering construction site. It may be hammer drills, chisels, core drills, angle or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices can be “power tools” in the context of the invention. The power tool may be in particular a mobile power tool, wherein the energy supply device can also be used in particular in stationary power tools, such as column-guided drills or circular saws. However, preference is given to hand-held power tools that are in particular rechargeable battery-operated or battery-operated.

It is preferred in the context of the invention that the at least one cell has a temperature cooling half-life of less than 12 minutes, preferably less than 10 minutes, particularly preferably less than 8 minutes. This preferably means in the context of the invention that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is present in a manner connected to a power tool. Energy supply devices with temperature cooling half-lives of less than 8 mins have primarily been found to be particularly suitable for use in powerful power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal loading on the components of the energy supply device or the power tool having the energy supply device can be considerably reduced. As a result, the energy supply device can be preserved and its service life extended.

It is preferred in the context of the invention that the at least one cell is arranged in a battery pack of the energy supply device. A series of individual cells can preferably be combined in the battery pack and in this way inserted into the energy supply device in an optimum manner. For example, 5, 6 or 10 cells may form a battery pack, wherein integer multiples of these numbers are also possible. For example, the energy supply device may have individual cell strings, which may comprise, for example, 5, 6 or 10 cells. An energy supply device having, for example, three strings of five cells each can comprise, for example, 15 individual cells.

In the context of the invention, it is preferred that the energy supply device has a capacity of at least 2.2 Ah, preferably at least 2.5 Ah. Tests have shown that the capacity values mentioned are particularly well suited to the use of high-powered power tools in the construction industry and satisfy the requirements there for the availability of electrical power and the possible service life of the power tool particularly well.

The at least one cell of the energy supply device is preferably configured to output a discharge current of at least 20 A for at least 10 s. For example, a cell of the energy supply device may be designed to provide a discharge current of at least 20 A, in particular at least 25 A, for at least 10 s. In other words, the at least one cell of an energy supply device can be configured to provide a continuous current of at least 20 A, in particular at least 25 A.

It is likewise conceivable that peak currents, in particular short-term peak currents, may lead to intense heating of the energy supply device. Therefore, an energy supply device with powerful cooling, as can be achieved by the measures described here, is particularly advantageous. It is conceivable, for example, that the at least one cell of the energy supply device can provide at least 50 A for 1 second. In other words, in the context of the invention, it is preferred for the at least one cell of the energy supply device to be configured to provide a discharge current of at least 50 A for at least 1 s. Power tools can often require high power outputs for a short period of time. An energy supply device of which the cells are capable of delivering such a peak current and/or such a continuous current may therefore be particularly suitable for powerful power tools such as those used on construction sites.

It is preferred in the context of the invention that the at least one cell comprises an electrolyte, wherein the electrolyte is preferably in a liquid state of aggregation at room temperature. The electrolyte can comprise lithium, sodium and/or magnesium, without be restricted thereto. In particular, the electrolyte can be lithium-based. As an alternative or in addition, said electrolyte can also be sodium-based. It is also conceivable for the storage battery to be magnesium-based. The electrolyte-based energy supply device can have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

It is preferred in the context of the invention for the energy supply device to be charged, for example, at a charging rate of 1.5 C, preferably 2 C and most preferably 3 C. A charging rate of xC can be understood as meaning the current intensity which is required to fully charge a discharged energy supply device in a fraction of an hour corresponding to the numerical value x of the charging rate x C. For example, a charging rate of 3 C makes it possible to fully charge the storage battery within 20 minutes.

It is preferred in the context of the invention that the at least one cell of the energy supply device has a surface area A and a volume V, wherein a ratio A/V of the surface area to the volume is greater than six times, preferably eight times and more preferably ten times, the reciprocal of the cube root of the volume.

The expression that the surface area A of the at least one cell is greater than eight times the cube root of the square of the volume V can preferably also be expressed by the formula >8*\hat{ }(/). Written another way, this relationship can be described in that the ratio A/V of surface area to volume is greater than eight times the inverse of the cube root of the volume.

For checking whether the above relationship is fulfilled, values in the same base unit must always be used. If for example a value for the surface area in m² is used in the above formula, preferably a value in the unit m³ is used for the volume. If for example a value for the surface area in the unit cm² is used in the above formula, preferably a value in the unit cm³ is used for the volume. If for example a value for the surface area in the unit mm² is used in the above formula, preferably a value in the unit mm³ is used for the volume.

Cell geometries which for example satisfy the relationship of >8*\hat{ }(/) advantageously have a particularly favorable ratio between the outer surface area of the cell, which is critical for the cooling effect, and the cell volume. The inventors have found that the ratio of the surface area to the volume of the at least one cell of the energy supply device has an important influence on the removal of heat from the energy supply device. The improved cooling capacity of the energy supply device can advantageously be achieved by increasing the cell surface area for a constant volume and a low internal resistance of the at least one cell. It is preferred in the context of the invention for a low cell temperature given a simultaneously high power output to preferably be able to be rendered possible when the internal resistance of the cell is reduced. Reducing the internal resistance of the at least one cell can result in less heat being generated. In addition, a low cell temperature can be achieved by using cells in which the surface area A of at least one cell within the energy supply device is greater than six times, preferably eight times, and particularly preferably ten times, the cube root of the square of the volume V of the at least one cell. It is thus possible in particular for the release of heat to the surroundings to be improved.

It has been found that energy supply devices whose cells satisfy the stated relationship can be cooled significantly more effectively than previously known energy supply devices having, for example, cylindrical cells. The above relationship can be satisfied, for example, by virtue of the fact that, although the cells of the energy supply device have a cylindrical basic shape, additional elements that increase the surface area are arranged on the surface thereof. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cube-like basic shape. The term “substantially” is unclear to a person skilled in the art here because a person skilled in the art knows that, for example, a cuboid with indentations or rounded corners and/or edges should also be covered by the term “substantially cuboidal” in the context of the present invention.

It is preferred in the context of the invention for the at least one cell to have a cell core, wherein no point within the cell core is more than 5 mm away from a surface of the energy supply device. When the energy supply device is discharged, for example when it is connected to a power tool and work is performed with the power tool, heat can be produced in the cell core. In this specific configuration of the invention, this heat can be transported on comparatively short paths of travel as far as the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the temperature being reached can advantageously be entirely avoided. As a further advantage of the invention, a relatively homogeneous temperature distribution can be achieved within the cell core. This can result in uniform aging of the storage battery. This can in turn increase the service life of the energy supply device.

It is preferred in the context of the invention for the at least one cell to have a maximum constant current output of greater than 20 amperes, preferably greater than 30 amperes, most preferably greater than 40 amperes. The maximum constant current output is the quantity of current in a cell or an energy supply device that can be drawn without the cell or the energy supply device reaching an upper temperature limit. Possible upper temperature limits can lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 20 and 30 A, that is to say 21, 22.3, 24, 25.55 or 27.06 amperes for example, should also be considered to be disclosed in the case of the maximum constant current output. Furthermore, values of between 30 and 40 A, that is to say 32, 33.3, 36, 38.55 or 39.07 amperes for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating powerful power tools in the construction industry. For example, the discharge currents can lie in a region of greater than 40 amperes, preferably greater than 60 amperes or even more preferably greater than 80 amperes.

In the context of the invention, it is preferred for the cell to have a cell temperature gradient of less than 10 kelvins. The cell temperature gradient is preferably a measure of temperature differences within the at least one cell of the energy supply device, wherein it is preferred in the context of the invention for the cell to have a temperature distribution that is as uniform as possible, that is to say for a temperature in an inner region of the cell to differ as little as possible from a temperature which is measured in the region of a lateral or outer surface of the cell.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a preferred embodiment of the system composed of power tool and energy supply device;

FIG. 2 shows a possible embodiment of the top side of an energy supply device of a preferred embodiment of the system;

FIG. 3 shows a possible embodiment of a unit composed of female and male contact partners;

FIG. 4 shows a further possible embodiment of a unit of female and male contact partners;

FIGS. 5a, 5b and 5c show an illustration of a possible process of connecting an energy supply device and power tool;

FIGS. 6a, 6b, 6c and 6d show an illustration of various combinations of spring mountings and arrangements of the contact partners;

FIGS. 7a, 7b, 7c and 7d show an illustration of various arrangements of the contact partners and the occupancies thereof;

FIGS. 8a and 8b show an illustration of a preferred configuration of the receiving device; and

FIGS. 9a and 9b show an illustration of a possible integration of communication elements or of a communication receiving device into the interface.

### DETAILED DESCRIPTION

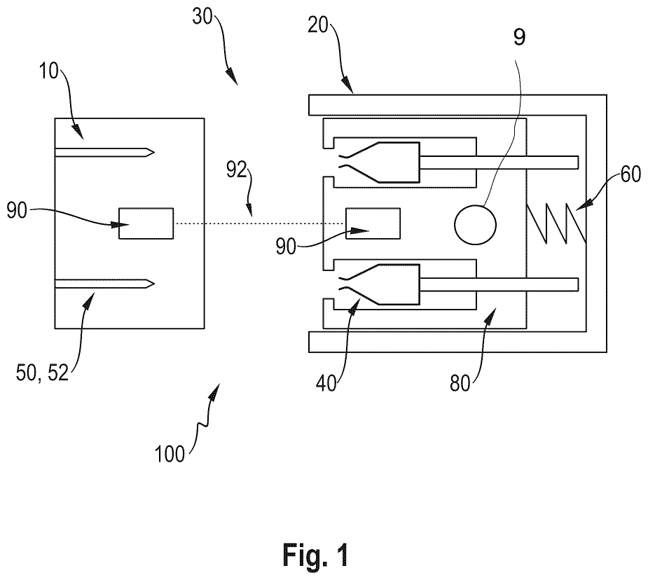

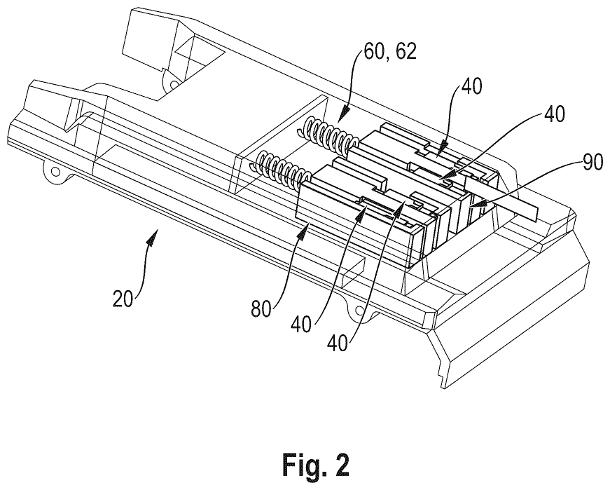

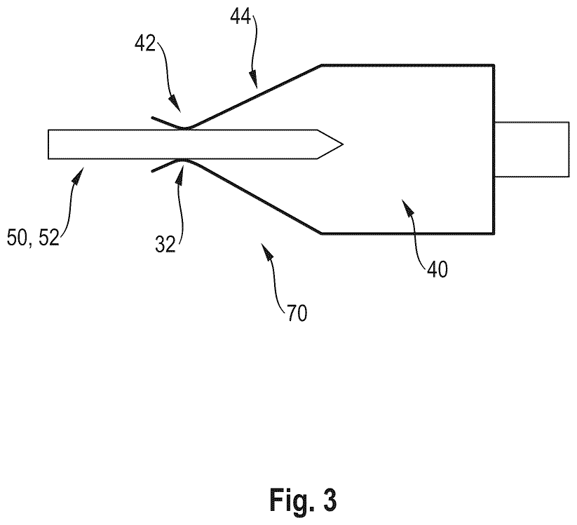

FIG. 1 shows a possible embodiment of the system 100 of power tool 10 and energy supply device 20 having a cell 9 shown solely schematically. In the exemplary embodiment of the invention shown in FIG. 1, the power tool 10 is illustrated in the left image half and the energy supply device 20 in the right image half. The power tool 10 has two male contact partners 50, wherein in particular the blades 52 are shown in FIG. 1. The male contact partners 50 are part of an interface 30, wherein the interface 30 in addition also has female contact partners 40. In the exemplary embodiment of the invention illustrated in FIG. 1, the female contact partners 40 are arranged on the energy supply device 20. The female contact partners 40 may constitute individual contacts, or as illustrated in FIGS. 1 and 2, be integrated in a block or compartment. The block or compartment with the female contact partners 40 is described as the receiving device 80 (see FIG. 2). FIG. 1 shows in particular the case in which the power tool 10 and the energy supply device 20 are separate from one another. The power tool 10 and the energy supply device 20 may together form a system 100, wherein the energy supply device 20 is configured to supply the power tool 10 with electrical energy. In addition, the interface 30 comprises an elastic means 60 for reducing the relative distance between the male contact partners 50 and the female contact partners 40. The at least one elastic means 60 may comprise an elastic element 62 which may for example be a spring or a spiral spring. However, all other conceivable elastic elements 62 are possible and conceivable. When the male contact partners 50 are introduced into the female receiving terminals 40, the elastic means 60 for reducing the relative distance are compressed so that a particularly stable contact is created between the contact partners 40, 50. Such a contact is shown in FIG. 3. By contact of the contact partners 40, 50 and compression of the elastic means 60 for reducing a relative distance, a play or movement space results in which a unit 70 (see FIG. 3) of a male contact partner 50 and a female contact partner 40 may be present. A movement or vibration of the energy supply device 20 then leads to the unit 70 of male contact partner 50 and female contact partner 40 having sufficient play not to impact on the boundary walls of the movement space. Thus the energy supply device 20 is decoupled from the unit 70 of male contact partner 50 and female contact partner 40, whereby the unit 70 of male contact partner 50 and female contact partner 40 is particularly well protected. The stable contact between the contact partners 40, 50 means that particularly high currents can flow from the energy supply device 20 to the power tool 10. This is achieved in particular because the contact resistance between the contact partners 40, 50 can be substantially reduced with the invention, so that in particular also the temperatures measured in a contact region 32 (see FIG. 3) between the contact partners 40, 50 rise less greatly than in conventional interfaces as known from the prior art. Because of the reduced contact resistance and reduced temperatures in the contact region 32 of the interface 30, gratifyingly, the service life of the interface 30 is extended.

Although FIG. 1 shows that the male contact partners 50 are arranged on the power tool 10, and the female contact partners 40 on the energy supply device 20, a reversed arrangement may also be possible in which the male contact partners 50 are arranged on the energy supply device 20 and the female contact partners 40 on the power tool 10. In particular, in the context of the invention, it may also be preferred that the male contact partners 50 are spring-mounted, i.e. are connected to an elastic means 60 for reducing a relative distance.

FIG. 2 shows a possible embodiment of the top side of an energy supply device 20 of a preferred embodiment of the system 100. The figure shows four female contact partners 40 which are arranged in a receiving device 80. In an exemplary embodiment of the invention, the receiving device 80 may also receive male contact partners 50, or male contact partners 50 and female contact partners 40. The receiving device 80 is in particular configured to receive the power or current contacts 40, 50 of the interface 30.

The interface 30 may include communication elements 90 that may, for example, be disposed in the region of the receiving device 80 or may be a component of the receiving device 80. The communication elements 90 can be arranged in the middle or centrally in the receiving device 80 and can be provided for transmitting data between the power tool 10 and the energy supply device 20. Furthermore, FIG. 2 shows two elastic elements 62, which are formed as springs, in particular spiral springs. The springs 62 form means 60 for reducing a relative distance between the current or power contacts 40, 50 of the interface 30. The communication elements 90 can be designed to establish a communication link 92 between the power tool 10 and the energy supply device 20, wherein the communication link 92 can be of wired or wireless design. The communication link 92 is schematically shown in FIG. 1 by the dashed line between the communication elements 90.

The receiving device 80 can further comprise communication elements 90, which are preferably arranged in the middle or centrally in the receiving device 80. The communication elements 90 are preferably provided for transmitting data between the power tool 10 and the energy supply device 20. Furthermore, FIG. 2 shows two elastic elements 62, which are formed as springs, in particular spiral springs. The springs 62 form means 60 for reducing a relative distance.

FIG. 3 shows a further possible embodiment of a unit 70 of a female contact partner 40 and a male contact partner 50. FIG. 3 in particular shows an interface 30 (see, e.g., FIG. 1) which has a female contact partner 40 and a male contact partner 50. In particular, FIG. 3 shows a connected state in which the energy supply device 20 and the power tool 10 have been connected together such that current or electrical energy can flow from the energy supply device 20 toward the power tool 10. The blade 52 of the male contact partner 50 is arranged in the receiving terminal 44 or legs 44 of the female contact partner 40, wherein the contact partners 40, 50 together form a contact region 32 via which the current or electrical energy can be transmitted from the energy supply device 20 to the power tool 10. The contact region 32 is formed in particular in the region of a taper 42 of the female contact partner 40, in which the legs 44 or the components of the receiving terminal 44 of the female contact partner 40 adopt a minimum distance from one another. As a result, the legs 44 of the female contact partner 40 lie particularly closely against the blade 52 of the male contact partner 50.

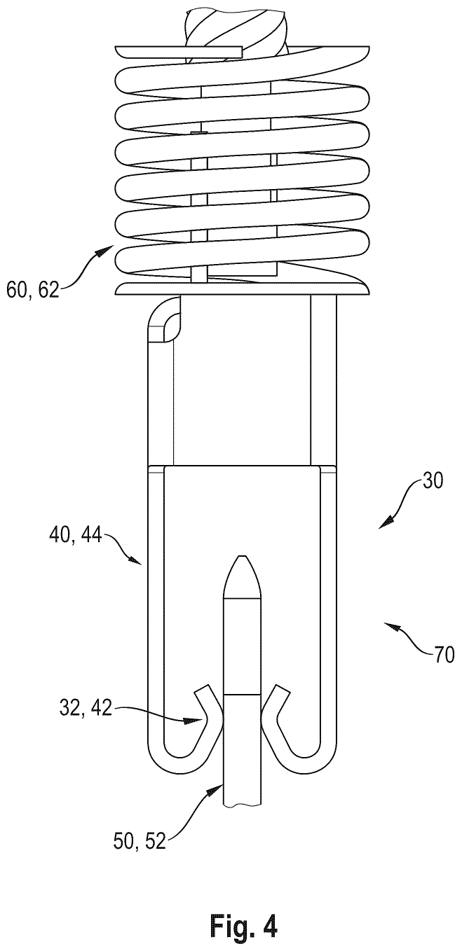

FIG. 4 shows a further possible embodiment of a unit 70 of a female contact partner 40 and a male contact partner 50. FIG. 4 shows in particular an interface 30 which has a female contact partner 40 and a male contact partner 50, and an elastic means 60 for reducing the relative distance between the contact partners 40, 50. The blade 52 of the male contact partner 50 is received by an interior of the female contact partner 40, wherein this interior is formed by the legs 44 of the female contact partner 40. The contact between the contact partners 40, 50 is present in particular in a contact region 32 of the interface 30 which, in the exemplary embodiment of the invention illustrated in FIG. 4, is arranged in the region of the smallest distance between the legs 44 of the female contact partner 40.

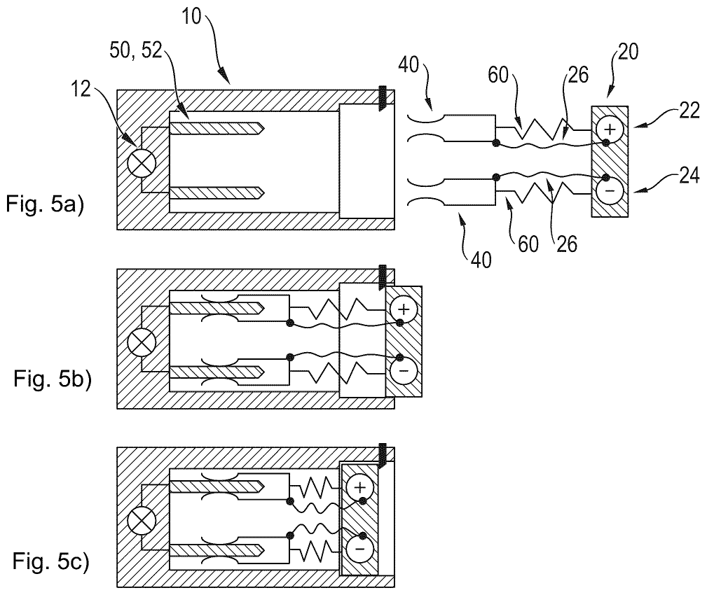

FIGS. 5a, 5b and 5c show a possible process of connecting an energy supply device 20 and a power tool 10. FIG. 5a shows the energy supply device 20 and power tool 10 in a separated state, in which the energy supply device 20 and power tool 10 are separate from one another. FIG. 5b shows the energy supply device 20 and power tool 10 at the moment in which the contact partners 40, 50 of the energy supply device 20 and of the power tool 10 have been brought together or pushed onto one another, wherein the elastic spring-mounting means 60 have not yet been elastically deformed in the state shown in FIG. 5b. This means that the elastic spring-mounting means 60 have not yet been stressed in the state shown in FIG. 5b, such that there is as yet no spring mounting of the contact partners 40, 50. FIG. 5c shows that the elastic spring-mounting means 60 have now been compressed, i.e. stressed. This state preferably corresponds to the locked state in which the energy supply device 20 and power tool 10 have been connected together, and in which the energy supply device 20 can supply electrical energy to the power tool 10.

The energy supply device 20 has a positive pole 22 and a negative pole 24, wherein a respective pole 22, 24 may be connected via a respective current conductor 26 to a contact partner, here a male contact partner 50. The current conductors 26 may preferably form an elastic current connection 26 between the spring-mounted female contact partners 40 in FIG. 5 and the energy supply device 20. The elastic spring-mounting means 60 preferably connect the contact partners, here the female contact partners 40, to the energy supply device 20. The power tool 10 may have a consumer 12 which may for example be the motor 12 of the power tool 10. The reference signs in FIG. 5a apply analogously to FIGS. 5b and 5c.

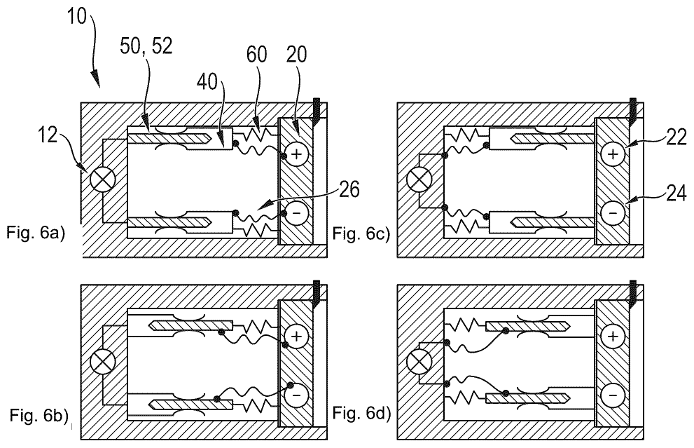

FIGS. 6a, 6b, 6c, and 6d show various combinations of spring mountings and arrangements of the contact partners 40, 50. FIG. 6a shows in an exemplary embodiment two male contact partners 50 with their blades 52 arranged on the power tool 10. The power tool 10 may comprise a consumer 12, for example a motor. FIGS. 6a, 6b, 6c and 6d show the power tool 10 and the energy supply device 20 in each case in the connected state. In the exemplary embodiment of the invention shown in FIG. 6a, the female contact partners 40 are present on the energy supply device 20, wherein the energy supply device 20 illustrated has in particular two female contact partners 40. In the exemplary embodiment of the invention shown in FIG. 6a, the number of female contact partners 50 thus corresponds to the number of male contact partners 40. In this context, this preferably means that the power tool 10 and the energy supply device 20 have the same number of contact partners 40, 50, wherein the power tool 10 shown in FIG. 6a has two male contact partners 50 and the energy supply device 20 shown in FIG. 6a has two female contact partners 40. The energy supply device 20 has two poles 22, 24, namely a positive pole 22 and a negative pole 24. The poles 22, 24 of the energy supply device 20 are each connected to the contact partners 40 via a respective, preferably elastic current conductor 26, wherein the contact partners of the energy supply device 20 in FIG. 6a are female contact partners 40. In the exemplary embodiment of the invention shown in FIG. 6a, the spring mounting is present in the region, i.e. on the side, of the energy supply device 20. In the exemplary embodiments of the invention shown in FIGS. 6a and 6d, the male contact partners 50 are each present on the power tool 10, whereas the female contact partners 40 are connected to the energy supply device 20. The reference signs in FIG. 6a apply analogously to the other figures of FIGS. 6b, 6c and 6d.

Part FIG. 6b shows an exemplary embodiment of the invention in which the power tool 10 has female contact partners 40, and the energy supply device 20 has male contact partners 50. Here too, both the power tool 10 and the energy supply device 20 have in each case two contact partners 40, 50. In the exemplary embodiment of the invention shown in FIG. 6b, the blades 52 of the male contact partners 50 are each connected to the energy supply device 20 via an elastic spring-mounting means 60, while the blades are also electrically connected to a respective pole 22, 24 of the energy supply device 20 via a current conductor 26. In the exemplary embodiment of the invention shown in FIG. 6b, too, the spring mounting is present in the region, i.e. on the side, of the energy supply device 20.

In the exemplary embodiments of the invention shown in FIGS. 6c and 6d, the spring mounting is present in each case in the region, i.e. on the side, of the power tool 10. FIG. 6c also shows an exemplary embodiment of the invention in which the power tool 10 has female contact partners 40, and the energy supply device 20 has male contact partners 50. The female contact partners 40 are conductively connected to the power tool 10 via a current conductor 26, wherein the electrical connection exists in particular between the female contact partners 40 and the consumer 12 of the power tool 10. The female contact partners 40 are also connected to the power tool 10 via elastic spring-mounting means 60. In the region of the energy supply device 20, the male contact partners 50, in particular their blades 52, are each connected to a pole 22, 24 of the energy supply device 20. The energy supply device 20 has two male contact partners 50, wherein precisely one male contact partner 50 may be assigned to each pole 22, 24 of the energy supply device 20.

Part FIG. 6d also shows an exemplary embodiment of the invention in which the power tool 10 has male contact partners 50, and the energy supply device 20 has female contact partners 40. In the exemplary embodiment of the invention shown in FIG. 6d, the spring mounting, i.e. the elastic spring-mounting means 60, is present in the region of the power tool 10. The power tool 10 is connected to a respective male contact partner 50 or its blade 52 via the elastic spring-mounting means 60. In addition, in the exemplary embodiment of the invention shown in FIG. 6d, a current-conducting connection exists between the consumer 12 of the power tool 10 and the male contact partners 50. The current-conducting connection between the consumer 12 of the power tool 10 and the male contact partners 50 may in particular be achieved by a current conductor 26, wherein the current conductor 26 can preferably be elastic. An elastic current conductor 26 is advantageously particularly highly suitable for assisting the movability of the contact partners 40, 50, such that optimum decoupling of the contact partners 40, 50 can be ensured. In the context of the invention, it may be preferred that the preferably elastic current conductor 26 comprises or is formed by a braided wire. Preferably, the preferably elastic current conductor 26 comprises several individual wires which may preferably have been twisted together. For example, in the context of the invention, it may be preferred that the preferably elastic current conductor 26 comprises more than ten individual wires. In the exemplary embodiment of the invention shown in FIG. 6d, the energy supply device 20 has two female contact partners 40, wherein each female contact partner 40 of the energy supply device 20 may be assigned to a respective one of the two poles 22, 24 of the energy supply device 20.

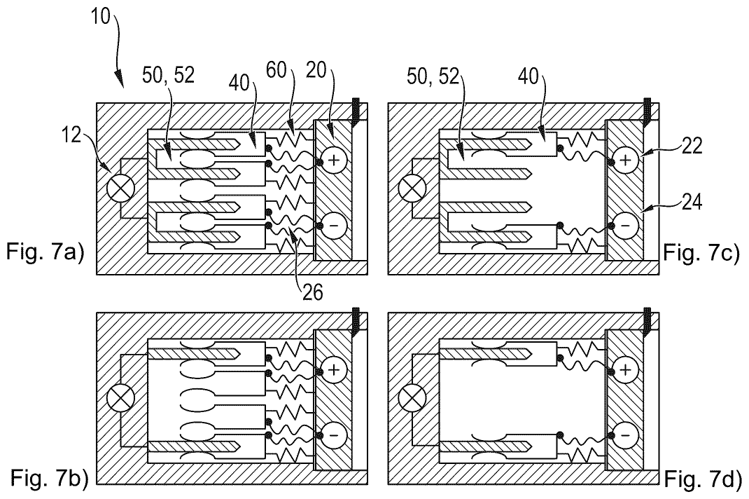

FIGS. 7a, 7b, 7c and 7d show various arrangements of the contact partners 40, 50 and the occupancies thereof. FIG. 7a shows a power tool 10 with four male contact partners 50 and an energy supply device 20 with four female contact partners 40. The male contact partners 50 of the power tool 10 are conductively connected to a consumer 12 of the power tool 10, in order to supply this with electrical energy which the power tool 10 receives from the energy supply device 20. The female contact partners 40 of the energy supply device 20 are each connected by a respective conductor to a pole 22, 24 of the energy supply device 20, wherein in the exemplary embodiment of the invention shown in FIG. 7a, two female contact partners 40 are connected to the positive pole 22 of the energy supply device 20, and two other female contact partners 40 are connected to negative pole 24 of the energy supply device 20. The connection can preferably be established with a preferably elastic current conductor 26. In addition, the female contact partners 40 are connected to the energy supply device 20 via an elastic spring-mounting means 60. The spring mounting in all FIGS. 7a, 7b, 7c and 7d takes place on the side of the energy supply device 20. In addition, a common feature is that the male contact partners 50 are present on the power tool 10, whereas the female contact partners 40 are arranged on the energy supply device 20. The figures of FIGS. 7a, 7b, 7c and 7d however differ with regard to the number of respectively present contact partners 40, 50, and the number of current transmission pairs that can be formed in each case. In the exemplary embodiment of the invention shown in FIG. 7a, four current transmission pairs are shown by way of example, each being composed of a female contact partner 40 and a male contact partner 50. With four current transmission pairs, a potential of the energy supply device 20 can be particularly effectively utilized, and a large quantity of electrical energy can be transmitted from the energy supply device 20 to the power tool 10. For example, currents of more than 50 A, preferably more than 70 A and most preferably more than 100 A can be transmitted with such an interface 30. The currents are preferably constant currents. The reference signs in FIG. 7a apply analogously to FIGS. 7b, 7c and 7d.

In the exemplary embodiment of the invention shown in FIG. 7b, two current transmission pairs are shown by way of example, each comprising a female contact partner 40 and a male contact partner 50, whilst two female contact partners 40 of the energy supply device 20 are not occupied, i.e. remain unused or “empty”. In the exemplary embodiment of the invention shown in-FIG. 7b, owing to the lower number of current transmission pairs, less current can be transmitted from the energy supply device 20 to the power tool 10 than in the exemplary embodiment of the invention shown in FIG. 7a, in which the interface 30 comprises four current transmission pairs. In the exemplary embodiment of the invention shown in FIG. 7b, the energy supply device 20 has four female contact partners 40, but the power tool 10 only has two male contact partners 50.

In the exemplary embodiment of the invention shown in FIG. 7c, it is likewise the case that two current transmission pairs are shown by way of example, each comprising a female contact partner 40 and a male contact partner 50, whilst two male contact partners 50 of the energy supply device 10 are not connected to a female contact partner 40. In the exemplary embodiment of the invention shown in FIG. 7c, owing to the lower number of current transmission pairs, less current can be transmitted from the energy supply device 20 to the power tool 10 than in the exemplary embodiment of the invention shown in FIG. 7a, in which the interface 30 comprises four current transmission pairs. In the exemplary embodiment of the invention shown in FIG. 7c, the power tool 10 has four male contact partners 50, but the energy supply device 20 only has two female contact partners 40.

In the exemplary embodiment of the invention shown in FIG. 7d, the power tool 10 has two male contact partners 50, and the energy supply device 20 has two female contact partners 40. Thus, two current transmission pairs are formed, and the amount of energy to be transmitted, or the magnitude of the currents that can be transmitted, corresponds to the exemplary embodiments of the invention shown in FIGS. 7b and 7c.

In the exemplary embodiments of the invention shown in FIGS. 5a to 7d, an individual spring mounting is shown in each case, that is to say, on that connection partner of the interface 30 at which the spring mounting takes place, each contact partner 40, 50 has an elastic spring-mounting means 60. This means that the contact partners 40, 50 are individually spring-mounted.

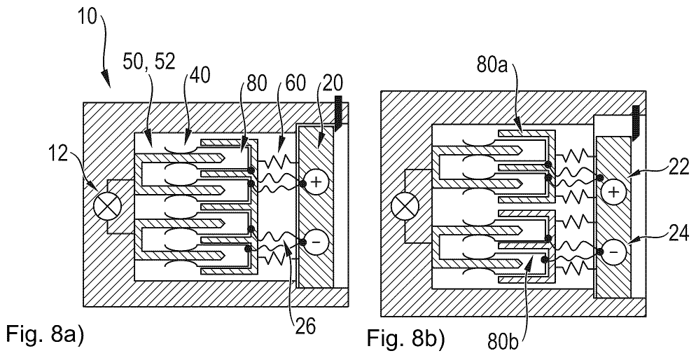

FIGS. 8a and 8b show receiving devices 80 which, in the exemplary embodiment of the invention shown in FIG. 8a, comprise the four female contact partners 40 of the energy supply device 20. The female contact partners 40 have been operatively connected in a known manner to the blades 52 of the male contact partners 50 such that current transmission pairs are formed, wherein, in the exemplary embodiment of the invention shown in FIG. 8a, four current transmission pairs are formed. The receiving device 80 shown in FIG. 8a is part of the energy supply device 20 and is connected to the poles 22, 24 of the energy supply device 20 via four current conductors 26, and mechanically connected to the energy supply device 20 via two spring-mounting means 60. The receiving device 80 preferably forms a contact block which can be spring-mounted as a block with a specific number of elastic spring-mounting means 60.

In the exemplary embodiment of the invention shown in FIG. 8b, two receiving devices 80 are shown, wherein two female contact partners 40 are present in each receiving device 80. Each of the two receiving devices 80 is connected to the energy supply device 20 via two elastic spring-mounting means 60, and to the poles 22, 24 of the energy supply device 20 via two current conductors 26. Here, in each case two current conductors 26 provide a connection between the positive pole 22 of the energy supply device 20 and the first receiving device 80a, while two other current conductors 26 provide the connection between the negative pole 24 of the energy supply device 20 and the second receiving device 80b. The reference signs in FIG. 8a apply analogously to FIG. 8b.

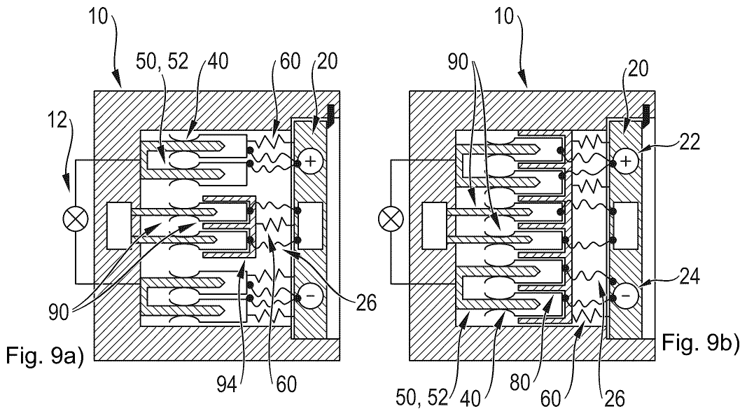

FIGS. 9a and 9b shows a possible integration of communication elements 90 or of a communication receiving device 94 into the interface 30. The power tool 10 shown in FIG. 9a has four male contact partners 50, which are each connected to a female contact partner 40 of the energy supply device 20 and form a current transmission pair. The interface 30 shown in FIG. 9a thus has four current transmission pairs. The spring mounting is provided in the exemplary embodiment of the invention shown in FIG. 9a on the energy supply device 20, wherein each of the four female contact partners 40 of the energy supply device 20 is connected to the energy supply device 20 via an elastic spring-mounting means 60.

In the exemplary embodiment of the invention shown in FIG. 9a, the female contact partners 40 are individually spring mounted. In each case two female contact partners 40 of the energy supply device 20 are connected via a current conductor 26 to the positive pole 22 of the energy supply device 20, whereas the two other female contact partners 40 of the energy supply device 20 are connected via a current conductor 26 to the negative pole 24 of the energy supply device 20.

The interface 20 shown in FIG. 9a additionally has communication elements 90, wherein two male communication elements 90 are present on the power tool 10 and two female communication elements 90 are on the energy supply device 20. Of course, two female communication elements 90 can be present on the power tool 10 and two male communication elements 90 can be present on the energy supply device 20. The communication elements 90 have their own communication receiving device 94, which can be spring mounted separately, i.e., independently of the power contacts 40, 50. For this purpose, the communication receiving device 94 can comprise its own elastic spring-mounting means 60.

In the exemplary embodiment of the invention shown in FIG. 9b, a common receiving device 80 is formed, which is designed for receiving both the power contacts 40, 50 and the communication elements 90. The receiving device 80 in FIG. 9b is spring mounted via two elastic spring-mounting means 60, i.e., in the exemplary embodiment of the invention shown in FIG. 9b the contact block as a whole is spring mounted via two elastic spring-mounting means 60. Of course, the receiving devices 80 can also be arranged on the power tool 10, wherein the receiving devices 80 on both sides—power tool 10 and energy supply device 20—can receive male contact partners 50 or female contact partners 40.

### LIST OF REFERENCE SIGNS

10 Power tool
12 Consumer in the power tool, e.g. motor
20 Energy supply device
22 Positive pole of energy supply device
24 Negative pole of energy supply device
26 Current conductor
30 Interface
32 Contact region
40 Female contact partner
42 Taper
44 Leg of female contact partner
50 Male contact partner
52 Blade
60 Means for reducing a relative movement
62 Elastic element
70 Unit of female and male contact partners
80 Receiving device
90 Communication element
92 Communication link
94 Communication receiving device
100 System

What is claimed is:

1-14. (canceled)

15. A system comprising:
a power tool; and
an energy supply device for supplying the power tool with electrical energy, the energy supply device releasably connectable to the power tool via an interface, the interface including at least a female contact partner and a male contact partner, the interface including at least one elastic means for reducing a relative movement between the contact partners, the elastic means for reducing the relative movement between the contact partners is designed to act on the male contact partner or on the female contact partner, the energy supply device having at least one energy storage cell, wherein the at least one energy storage cell has an internal resistance DCR_I of less than 10 milliohms.

16. The system as recited in claim 15 wherein the male or female contact partner on which the elastic means for reducing the relative movement acts is movably mounted.

17. The system as recited in claim 15 wherein the male contact partner is arranged on the power tool or the female contact partner is arranged on the energy supply device.

18. The system as recited in claim 15 wherein the at least one elastic means for reducing the relative movement includes a spring.

19. The system as recited in claim 15 wherein the male contact partner and the female contact partner form a unit decoupled in a connected state from a movement of the energy supply device or from a movement of the power tool.

20. The system as recited in claim 15 wherein the interface has at least one elastic current conductor.

21. The system as recited in claim 15 wherein the interface includes communication elements for exchanging data between the power tool and the energy supply device.

22. The system as recited in claim 21 wherein the communication elements form a communication link, wherein the communication link is wire-based.

23. The system as recited in claim 21 wherein the communication elements form a communication link, wherein the communication link is without wires.

24. The system as recited in claim 21 wherein the communication elements are arranged in a communication receiving device, wherein the communication elements or the communication receiving device includes the elastic means.

25. The system as recited in claim 15 wherein the interface includes a receiver for receiving the female contact partner or the male contact partner.

26. The system as recited in claim 25 wherein the at least one communication element is integrated in the receiver.

27. The system as recited in claim 25 wherein the at least one elastic means for reducing the relative movement is assigned to the receiver.

28. The system as recited in claim 15 wherein the at least one elastic means for reducing the relative movement is assigned to a pair of the female contact partner and the male contact partner.

29. An energy supply device for use in the system as recited in claim 15, the energy supply device comprising the at least one energy storage cell, wherein a ratio of a resistance of the at least one energy storage cell to a surface area A of the at least one energy storage cell is less than 0.2 milliohms/cm².

30. The energy supply device as recited in claim 29 wherein the ratio is less than 0.1 milliohms/cm².

31. The energy supply device as recited in claim 29 wherein the ratio is less than 0.05 milliohms/cm².

32. An energy supply device for use in the system as recited in claim 15, the energy supply device comprising the at least one energy storage cell, wherein the at least one energy storage cell has a surface area A and a volume V, wherein the ratio A/V of the surface area to the volume is greater than six times the inverse of the cube root of the volume.

33. The energy supply device as recited in claim 33 wherein the ratio A/V is greater than eight times the inverse of the cube root of the volume.

34. The energy supply device as recited in claim 33 wherein the ratio A/V is greater than ten times the inverse of the cube root of the volume.
